(19) United States
(12) Patent Application Publication
(10) Pub. No.: US 2013/0088506 A1
(43) Pub. Date: Apr. 11, 2013

(54) DISPLAY APPARATUS AND DRIVING METHOD THEREOF

(71) Applicants: Sang-un YUN, Seoul (KR); Jae-sung PARK, Anyang-si (KR); Min-cheol HWANG, Seoul (KR); Jun-ho SUNG, Seoul (KR)

(72) Inventors: Sang-un YUN, Seoul (KR); Jae-sung PARK, Anyang-si (KR); Min-cheol HWANG, Seoul (KR); Jun-ho SUNG, Seoul (KR)

(73) Assignee: SAMSUNG ELECTRONICS CO., LTD., Suwon-si (KR)

(21) Appl. No.: 13/615,260

(22) Filed: Sep. 13, 2012

(30) Foreign Application Priority Data
Oct. 5, 2011 (KR) 2011-0101326

(51) Int. Cl. G09G 5/02; G06K 9/40; G09G 5/10

(52) U.S. Cl. 345/589; 345/690; 382/167

(57) ABSTRACT

A display apparatus and a driving method thereof are provided. The display apparatus includes an image analysis unit which analyzes a correlation of an image by comparing a current image and a previous image input prior to the current image, and determines a level of correction of the current image according to the analysis of the correlation, and an image conversion unit which converts pixel values of pixels of a unit frame having a specific color in the current image based on the level of correction, and outputs the pixel values.

### CROSS-REFERENCE TO RELATED APPLICATION

This application claims priority from Korean Patent Application No. 10-2011-0101326, filed on Oct. 5, 2011, in the Korean Intellectual Property Office, the disclosure of which is incorporated herein by reference in its entirety.

### BACKGROUND

1. Field

Methods and apparatuses consistent with exemplary embodiments relate to a display apparatus and a driving method thereof, and more particularly, to a display apparatus which can improve color rendition by preventing color mixing of a color filterless liquid crystal display (CFL), for example, and a driving method thereof.

2. Description of the Related Art

A liquid crystal display (LCD) refers to a display apparatus that applies an electric field to a liquid crystal layer, which has anisotropic permittivity and is injected between two substrates. An amount of light passing through the substrates is adjusted by adjusting an intensity of the electric field, thereby obtaining a desired image signal.

Most of the related art LCDs form color filter layers consisting of three colors, red (R), green (G), and blue (B), on one of the two substrates, and adjusts an amount of light passing through the color filter layers, thereby displaying a desired color. In other words, the LCD makes white light emitted from a light source pass through the color filter layers of R, G, and B and adjusts an amount of light passing through the color filter layers of R, G, and B and combines the R, G, and B, thereby displaying a desired color.

In the LCD, which displays colors using the white light and the three color filter layers as described above, corresponding pixels are needed for each R, G, or B area and thus the pixels needed are three times more than the pixels needed when a monochrome image is displayed. Accordingly, a precise manufacturing technique of a liquid crystal panel is required in order to obtain a high-resolution image. Also, there are problems in that a separate color filter layer should be formed on a substrate and light transmittance of the color filter should be improved.

In view of this point, the LCD has recently adopted a field sequential color (FSC) method, which uses three color light sources. Specifically, the FSC method turns on an independent light source of each of the R, G, and B in sequence periodically and applies a color signal corresponding to each pixel in synchronization with a turn-on period, thereby obtaining a full color image. This method may be called a color filterless liquid crystal display (CFL). The CFL synchronizes a liquid crystal with light emitting diodes (LEDs) of R, G, and B, and drives the LEDs in sequence, accumulates the colors, and finally represents a color. The most important factor that determines color rendition of the CFL is a rapid operation of the liquid crystal and color separation by exact synchronization between backlight and the liquid crystal.

FIG. 1 is a view illustrating an operating principle and a color representing method of a related art CFL, and FIG. 2 is a view to explain the occurrence of color mixing and reduction of color rendition.

Referring to FIG. 1, a related art CFL synchronizes light of RGB LEDs with a liquid crystal and turns on the LEDs in sequence. The liquid crystal separates light and allows the light to pass with appropriate brightness, thereby representing colors, so that a person can finally recognize an accumulation of colors.

As described above, a panel of such a CFL drives R, G, and B images in sequence to represent colors. However, if colors are represented by such a consecutive color driving method, a color break up phenomenon may occur according to a persons' color recognition tendency.

In other words, even though the liquid crystal is exactly synchronized with the backlight during the color driving of the CFL, since a response speed of the liquid crystal is slower than that of the LED as shown in FIG. 2, it is impossible to separate color exactly. As a result, consecutive colors are mixed, reducing a color gamut and thus changing color coordinates.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a display apparatus which reduces color mixing by adaptively changing a pixel value for a specific pixel as needed, during a color driving operation of an image signal or at an interval between color driving operations, or by inserting a black frame or performing blinking of a backlight, and which improves color rendition by color correction, and a driving method thereof.

According to an aspect of an exemplary embodiment, there is provided a method for driving a display apparatus, the method including receiving a first image, correcting a driving voltage for at least one of a red (R) frame, a green (G) frame, and a blue (B) frame generated from the first image, according to a pixel value of a previously driven frame, and displaying the R frame, the G frame, and the B frame in sequence according to the corrected driving voltage.

The correcting the driving voltage may include correcting a driving voltage of one of the R frame, the G frame, and the B frame that is driven second, according to a pixel value of the one of the R frame, the G frame, and the B frame that is driven first, or correcting a driving voltage of the frame that is driven third, according to a pixel value of the one of the R frame, the G frame, and the B frame that is driven second.

The correcting the driving voltage may include correcting the driving voltage according to a pixel value of a second image that is received before the first image is received.

The correcting the driving voltage may include correcting the driving voltage according to a difference in pixel values between the previously driven frame and the at least one of the R frame, the G frame and the B frame which driving voltage is to be corrected.

The correcting the driving voltage may include correcting the driving voltage for each region of the at least one of the R frame, the G frame and the B frame which driving voltage is to be corrected.

The correcting the driving voltage may include correcting the driving voltage according to a temperature factor.

The correcting the driving voltage may include, if the R frame, the G frame, and the B frame are driven in sequence, correcting the driving voltage so that color mixing is reduced.

The displaying may include displaying the R frame, the G frame, and the B frame in sequence by synchronizing a color filterless liquid crystal display (CFL) and an RGB backlight.

The displaying may include inserting a frame of a specific gray scale value when displaying the R frame, the G frame, and the B frame in sequence.

The displaying may include turning off a backlight in a specific section when displaying the R frame, the G frame, and the B frame in sequence.

According to an aspect of another exemplary embodiment, there is provided a method for driving a display apparatus, the method comprising: receiving a first image, and inserting at least one color mixing prevention section between an R frame, a G frame, and a B frame generated from the first image and displaying the R frame, the G frame, and the B frame in sequence.

The displaying may include inserting a frame of a specific gray scale value when displaying the R frame, the G frame, and the B frame in sequence.

The displaying may include turning off a backlight in a specific section when displaying the R frame, the G frame, and the B frame in sequence.

According to an aspect of another exemplary embodiment, there is provided a method for driving of a display apparatus, the method including receiving a current image currently input and a previous image input prior to the current image and analyzing a correlation of an image by comparing the previous image and the current image; and determining a level of correction of the current image according to the analysis of the correlation and converting the current image according to the level of correction.

The converting the current image may include converting pixel values for pixels of a unit frame having a specific color, when a unit frame of the current image is displayed in sequence on a pixel basis.

The converting the pixel values may include converting the pixel values into black data.

The converting the current image may include inserting a black frame between unit frames of two pixels having a specific color, when a unit frame of the current image is displayed in sequence on a pixel basis.

The converting the current image may include turning off a backlight in synchronization with a time at which pixels of a unit frame having a specific color are displayed, when a unit frame of the current image is displayed in sequence on a pixel basis.

The converting the current image may include turning off a backlight in synchronization with a time between when one of unit frames of two pixels having a specific color is displayed and when the other unit frame is displayed, when a unit frame of the current image is displayed in sequence on a pixel basis.

According to an aspect of still another exemplary embodiment, there is provided a display apparatus including an image correction unit which receives a first image and corrects a driving voltage for at least one of an R frame, a G frame, and a B frame generated from the first image, according to a pixel value of a previously driven frame, and a display panel which displays the R frame, the G frame, and the B frame in sequence according to the corrected driving voltage.

The image correction unit may correct a driving voltage of one of the R frame, the G frame, and the B frame that is driven second, according to a pixel value of the frame that is driven first, or may correct a driving voltage of the frame that is driven third according to a pixel value of the frame that is driven second.

The image correction unit may correct the driving voltage according to a pixel value of a second image that is received before the first image is received.

The image correction unit may correct the driving voltage according to a difference in pixel values between the previously driven frame and the corrected frame.

The image correction unit may correct the driving voltage for each region of the frame.

The image correction unit may correct the driving voltage according to a temperature factor.

If the R frame, the G frame, and the B frame are driven in sequence, the image correction unit may correct the driving voltage so that color mixing is reduced.

The display panel may be synchronized with RGB backlight and display the R frame, the G frame, and the B frame in sequence.

The image correction unit may insert a frame of a specific gray scale value when displaying the R frame, the G frame, and the B frame in sequence.

The image correction unit may turn off a backlight in a specific section when displaying the R frame, the G frame, and the B frame in sequence.

According to an aspect of still another exemplary embodiment, there is provided a display apparatus including an image correction unit which inserts at least one color mixing prevention section between an R frame, a G frame, and a B frame generated from a received first image, and a display panel which displays the R frame, the G frame, and the B frame in sequence.

The image correction unit may insert a frame of a specific gray scale value when displaying the R frame, the G frame, and the B frame in sequence.

The image correction unit may turn off a backlight in a specific section when displaying the R frame, the G frame, and the B frame in sequence.

According to an aspect of still another exemplary embodiment, there is provided a display apparatus including an image analysis unit which analyzes a correlation of an image by comparing a current image and a previous image input prior to the current image, and determines a level of correction of the current image according to the analysis of the correlation, and an image conversion unit which converts pixel values of pixels of a unit frame having a specific color in the current image based on the level of correction, and outputs the pixel values.

The image analysis unit may include a correlation analysis unit which analyzes the correlation of the image, and a calculation unit which calculates a correction coefficient to determine the level of correction.

The image analysis unit may be operated in association with a first memory unit, and the first memory unit may store the previous image and the current image.

The image conversion unit may convert the current image by converting the pixel values of the pixels of the unit frame having the specific color or inserting a black frame between unit frames of two pixels having a specific color, when a unit frame image is driven in sequence on a basis of R, G, and G pixels.

The image conversion unit may be operated in association with a second memory, and the second memory may pre-store the pixel values as a correction value in a form of a lookup table.

The image conversion unit may convert the pixel values to adjust a gamma voltage of the pixels of the unit frame having the specific color.

The converted pixel values of the pixels of the specific color may include a value of black data.

The image conversion unit may use at least one of the correlation, the level of correction, a response speed of a liquid crystal, and a temperature characteristic of a panel to convert the pixel values.

According to an aspect of another exemplary embodiment, there is provided a display apparatus including an image analysis unit which analyzes a correlation of an image by comparing a current image and a previous image input prior to the current image, and determines a level of correction of the current image according to the analysis of the correlation, and an image conversion unit which turns off a backlight, when a unit frame having a specific color in the current image is displayed in relation to determination of the level of correction.

The image conversion unit may turn off the backlight in synchronization with a time at which the pixels of the unit frame having the specific color are displayed or a time between when one of unit frames of two pixels having a specific color is displayed and when the other unit frame is displayed, when an image of a unit frame is driven in sequence on a basis of R, G, and B pixels.

The image conversion unit may be additionally operated in association with a lamp driver, and the lamp driver may turn off the backlight according to a request of the image conversion unit.

The image conversion unit may generate a control signal for the request and provide the control signal to the lamp driver so that the backlight is operated in synchronization with the control signal.

According to the exemplary embodiments, in the case of a CFL for example, a pixel value of a specific pixel is converted and displayed when an image is realized in sequence on a basis of R, G, and B pixels, or a blinking operation of a backlight is performed, so that color mixing can be prevented. Also, color rendition can be improved by enlarging a color gamut. As a result, image quality can be improved.

Additional aspects and advantages of the exemplary embodiments will be set forth in the detailed description, will be obvious from the detailed description, or may be learned by practicing the exemplary embodiments.

### BRIEF DESCRIPTION OF THE DRAWINGS

The above and/or other aspects will be more apparent by describing in detail exemplary embodiments, with reference to the accompanying drawings, in which:

FIG. 1 is a view illustrating an operating principle and a color representing method of a related art CFL;

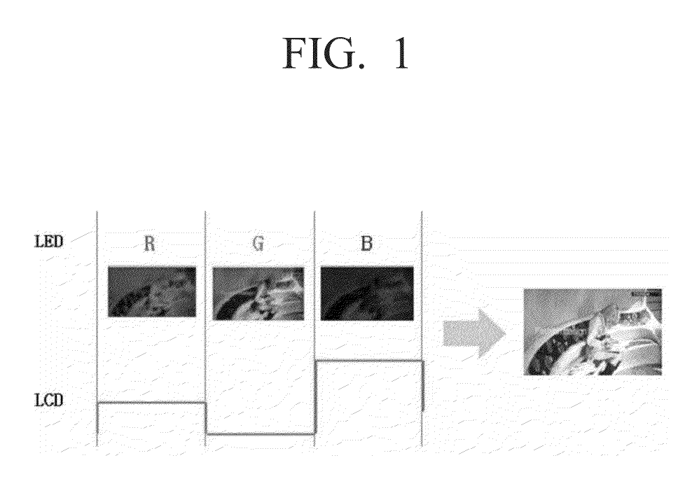

FIG. 2 is a view to explain an occurrence of color mixing and reduction of color rendition of the CFL;

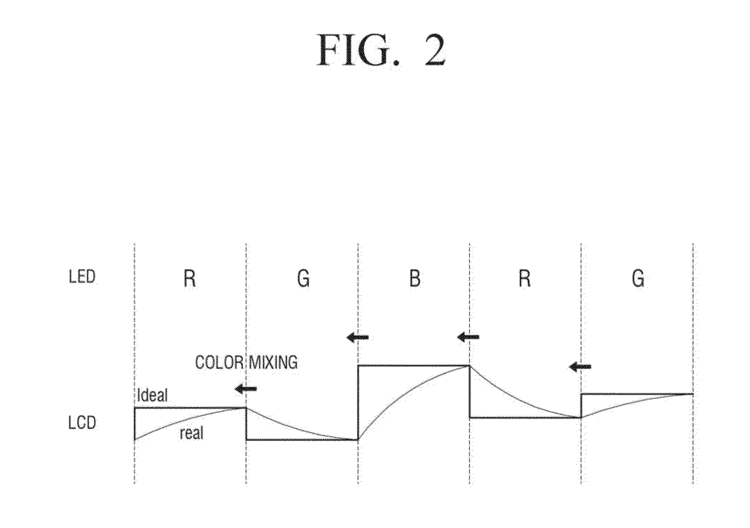

FIG. 3 is a block diagram illustrating a display apparatus according to an exemplary embodiment;

FIG. 4 is a block diagram illustrating an image correction unit of FIG. 3 in detail;

FIG. 5 is a view to explain a color correction applying principle of the image correction unit of FIG. 3;

FIG. 6 is a view to explain a result of applying a correction coefficient to each region by the image correction unit of FIG. 3;

FIG. 7 is a view to explain various examples of operations of inserting a black frame of the display apparatus of FIG. 3;

FIG. 8 is a flowchart illustrating a driving method of the display apparatus of FIG. 3 according to an exemplary embodiment; and

FIG. 9 is a flowchart illustrating a driving method of the display apparatus of FIG. 3 according to an exemplary embodiment.

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

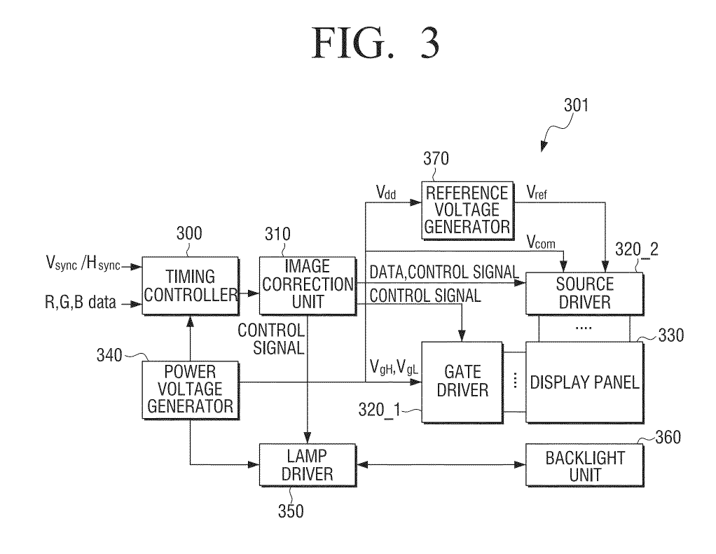

FIG. 3 is a block diagram illustrating a display apparatus 301 according to an exemplary embodiment.

As shown in FIG. 3, a display apparatus 301 according to an exemplary embodiment includes a timing controller 300, an image correction unit 310, a gate driver 320_1, a source driver 320_2, a display panel 330, a power voltage generator 340, a lamp driver 350, a backlight unit 360, and a reference voltage generator 370, in whole or in part.

The timing controller 300 may be operated in association with an interface, such as a graphic card, and may include a scaler and a control signal generator. The graphic card converts image data input from an external source according to a resolution of the display apparatus 301 and outputs the image data. The image data includes R, G, and B video data and the graphic card generates control signals, such as a clock signal (DCLK) and vertical and horizontal sync signals (Vsync and Hsync), suitable for the resolution of the display apparatus 301. The scaler receives R, G, and B data of 8 bits from the graphic card and re-arranges the data, for example, re-arranges the data to 6 bits.

The control signal generator generates a timing signal to control timing of the gate driver 320_1 and the source driver 320_2 in response to the control signal of the graphic card. At this time, the R, G, and B data rearranged by the timing controller 300 and the timing signal generated by the timing controller 300, that is, the control signal, are provided to the image correction unit 310. However, this should not be considered as limiting and the control signal may be directly provided to the gate driver 320_1 and the source driver 320_2 and the lamp driver 350 from the timing controller 300 according to a system designer's intention.

As one method for preventing a color mixing phenomenon on the display panel 330, the image correction unit 310 analyzes a variation in each pixel of a consecutively input image and changes a gray scale of a color, that is, a gray scale voltage, according to a result of the analyzing, thereby adaptively compensating for an insufficient response speed of a liquid crystal in the display panel 330. As another method, a black frame is inserted between colors when R, G, B colors are sequentially driven or a specific pixel is driven as a black frame, so that a response speed is guaranteed between the colors and color mixing is prevented when colors are represented and thus color rendition is improved.

As described above, the image correction unit 310 may analyze a variation in each pixel of an image and insert a black frame between pixels according to a result of the analyzing, or may apply a specific pixel as a black frame. Furthermore, the image correction unit 310 may control the lamp driver 350 to perform a blinking operation of tuning off the backlight unit 360.

In order to perform the above function, the image correction unit 310 receives the image data from the timing controller 300, compares a previous image and a current image, and analyzes a correlation between them. The image correction unit 310 may calculate a correction coefficient to determine a correction range based on a result of the analyzing, and may convert the input image using the image correlation, the calculated correction coefficient, and a separate setting value, and output the converted image. Converting the image may include converting a pixel value of a specific pixel to adjust a gray scale of a color, inserting a black frame between pixels, and performing a blinking operation of the backlight unit 360. Converting the pixel value of the specific pixel may include converting the pixel value to black data. Also, the setting value may include an already known variation value of a liquid crystal between gray scales of a specific color and a temperature value reflecting a temperature characteristic of the display panel 330.

The gate driver 320_1 receives gate on and off voltages (VgH and VgL) generated by the power voltage generator 340. The gate on and off voltages (VgH and VgL) are synchronized with the control signal provided from the image correction unit 310 or the control signal provided from the timing controller 300 and are applied to gate lines (GL1˜GLn) of the display panel 330. When applying the gate on and off voltages, the gate driver 320_1 may apply the gate on and off voltages to each of the horizontal lines in sequence under control of the image correction unit 310 or the timing controller 300.

The source driver 320_2 may receive a common voltage (Vcom) generated by the power voltage generator 340 and a reference voltage (Vref) (or a gamma voltage) provided from the reference voltage generator 370, and also may receive an original image without correction or corrected R, G, and B images and the control signal from the image correction unit 310. The common voltage (Vcom) is provided to a common electrode of the display panel 330 and the reference voltage (Vref) is provided to a D/A converter in the source driver 320_2 and is used to represent a gray scale of a color image.

In other words, the original image or the corrected R, G, and B images provided from the image correction unit 310 may be provided to the D/A converter and digital information of the R, G, and B images provided to the D/A converter is converted into an analog voltage that can represent the gray scale of the color and is provided to the display panel 330. At this time, the R, G, and B images, that is, the gray scale voltage may be synchronized with the control signal provided from the image correction unit 310 and may be provided to the display panel 330.

The display panel 330 includes a first substrate and a second substrate, and a liquid crystal layer disposed between the first and the second substrates. The first substrate includes a plurality of gate lines (GL1˜GLn) and a plurality of data lines (DL1˜DLn) which intersect to define a pixel region. A pixel electrode is formed on the pixel region in which the gate line and the data line intersect. A thin film transistor (TFT) is formed on one area of the pixel region, specifically, on a corner. When the TFT is turned on, the liquid crystal is twisted as much as a difference between a voltage applied to the pixel electrode of the first substrate and a voltage applied to a common electrode of the second substrate, thereby allowing R, G, and B light of the backlight unit 360 to pass in sequence. To allow the R, G, and B light to pass in sequence, the display panel 330 according to the exemplary embodiment may be a CFL, that is, a display panel without a color filter. In other words, the CFL forms three unit frames representing the R, G, and B light with respect to a unit frame of an input image in order to form the unit frames having various colors, and realizes an image.

The power voltage generator 340 receives a regular voltage, that is, an alternating current (AC) voltage of 110V or 220V, from an external source, generates and outputs various direct current (DC) voltages. For example, a DC 15V voltage may be generated as a gate on voltage (VgH) and may be provided to the gate driver 320_1, and a DC 24V voltage may be generated and provided to the lamp driver 350. A DC 12V voltage may be generated and provided to the timing controller 300.

The lamp driver 350 may convert the voltage provided from the power voltage generator 340 and may provide the voltage to the backlight unit 360. The lamp driver 350 may be operated in synchronization with the control signal provided from the image correction unit 310 in order to drive LEDs of R, G, and B of the backlight unit 360 in sequence. Also, the lamp driver 350 may include a feedback circuit to adjust driving currents of the LEDs in order for the R, G, and B LEDs of the backlight unit 360 to provide uniform light. Furthermore, according to a situation, the lamp driver 350 may be used to control a blinking operation of tuning off all of the R, G, and B LEDs according to the control signal provided from the image correction unit 310, when driving the R, G, and B LEDs in sequence.

The backlight unit 360 includes the R, G, and B LEDs and may be configured in any type such as an edge type in which the R, G, and B LEDs are arranged along an edge of the display panel 330 or a direct type in which the R, G, and B LEDs are arranged along an entire lower end of the display panel 330. However, the backlight unit 360 may be operated to provide the R, G, and B light in sequence or include a blinking section under control of the lamp driver 350.

The reference voltage generator 370 may be called a gamma voltage generator. For example, if a DC 10V voltage is provided from the power voltage generator 340, the reference voltage generator 370 may divide the voltage into a plurality of voltages through division resistance and provide the voltages to the source driver 320_2. The source driver 320_2 further divides the plurality of voltages and thus represents 256 grayscales of the R, G, and B data.

In the above exemplary embodiment, the display apparatus 301 includes the elements independently for convenience of explanation. However, the above exemplary embodiment can be changed in various forms. Although not shown, the image correction unit 310 of the display apparatus 301 of FIG. 3 may be included in the timing controller 300 and at least one of the gate driver 320_1 and the source driver 320_2 may be included in the display panel 330. For example, the gate and source drivers 320_1 and 320_2 may be mounted in the display panel 330 in a chip on glass (COG) method or may be formed on an appropriate area at the same time when the display panel 330 is manufactured. Therefore, it should be understood that the exemplary embodiments are not limited to the exemplary embodiment described above with reference to FIG. 3.

Also, the display apparatus 301 according to the exemplary embodiment may be diversely changed in a connecting relationship to provide the R, G, B data and the control signal. In other words, in FIG. 3, the image correction unit 310 receives the image data and the control signal from the timing controller 300, corrects the data, and provides the data to the source driver 320_2, and controls the gate driver 320_1 and the source driver 320_2 and the lamp driver 350 by retaining or re-generating the control signal. However, as mentioned above, the timing controller 300 may control at least one of the gate driver 320_1 and the source driver 320_2 and the lamp driver 350, according to a level of correction in cooperation with the image correction unit 310, and the image correction unit 310 may only correct the image data and then provide the corrected image data to the source driver 320_2. From this point, it should be understood that the exemplary embodiments are not limited to the exemplary embodiment described above with reference to FIG. 3.

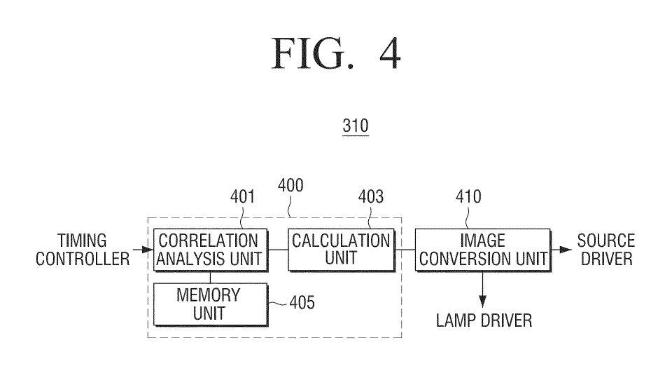

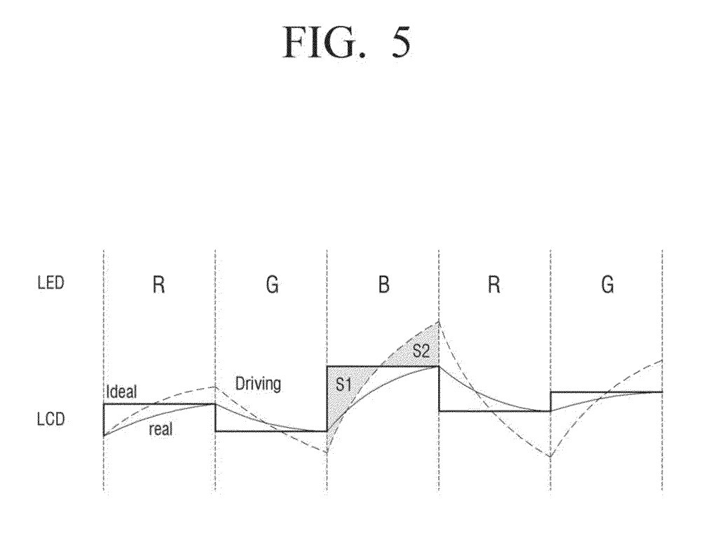

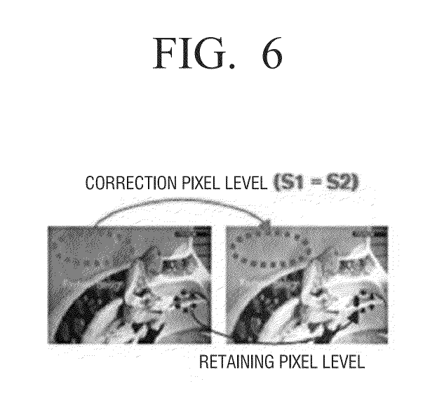

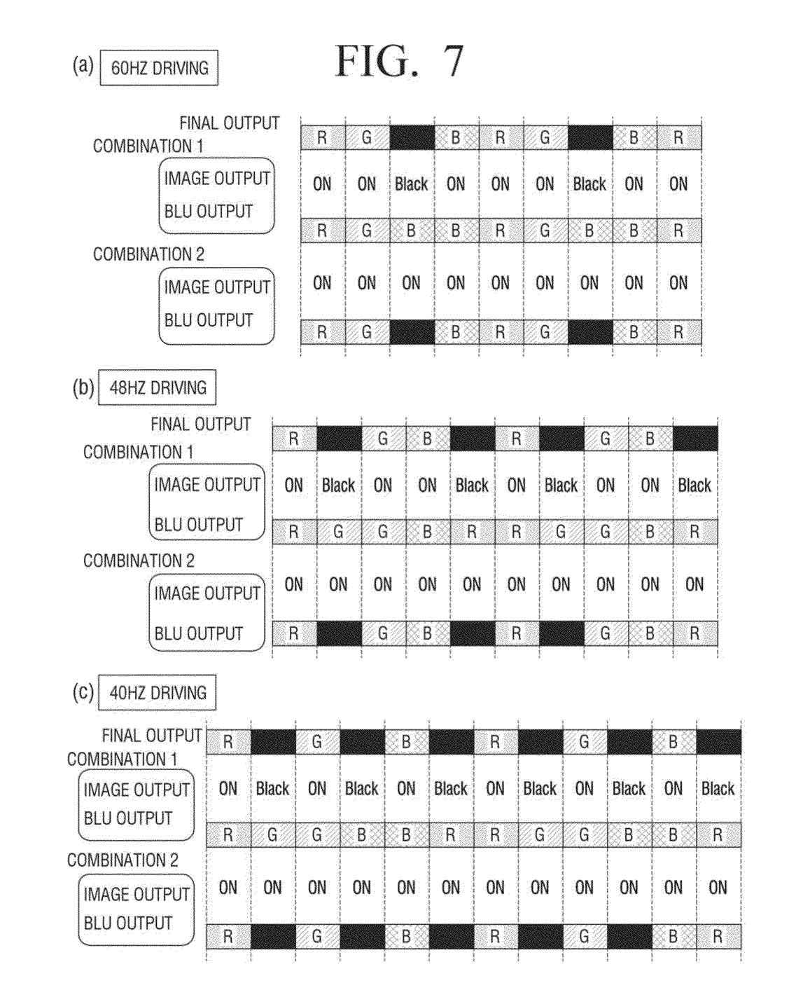

FIG. 4 is a block diagram illustrating the image correction unit 310 of FIG. 3 in detail, FIG. 5 is a view to explain a color correction applying principle of the image correction unit of FIG. 3, and FIG. 6 is a view to explain a result of applying a correction coefficient to each region by the image correction unit 310 of FIG. 3. FIG. 7 is a view to explain various examples of operations of inserting a black frame in the display apparatus 301 of FIG. 3.

Referring to FIG. 4 along with FIG. 3, the image correction unit 310 may include an image analysis unit 400 and an image conversion unit 410 and may further include a determination unit, a memory unit 405, and a switching unit in whole or in part. The image analysis unit 400 includes a correlation analysis unit 401 and a calculation unit 403.

The correlation analysis unit 401 analyzes variations in pixel values of a current frame image by referring to a previous unit frame image or two or more unit frame images on a basis of a unit frame regarding a currently input image or on a basis of a macro block into which the unit frame is divided. At this time, to analyze a correlation, the correlation analysis unit 401 may compare pixels corresponding to the same position and analyze variations in pixel values. However, the correlation analysis unit 401 may analyze the correlation in various ways such as using values of neighboring pixels of a specific pixel or using an average value of the neighboring pixels. The correlation analysis unit 401 may be operated in association with the memory unit 405 to analyze the correlation.

The calculation unit 403 performs calculation to calculate a correction coefficient and determines a level of correction between gray scales. In other words, since color mixing caused by a response speed of a liquid crystal is changed according to a variation in a pixel value and a temperature of the display panel 330, and causes a difference, the level of correction of the pixel value should be adjusted according to a situation. That is, as a variation of a liquid crystal in a color gray scale is greater, colors are more highly affected by the response speed and thus many colors are mixed. On the other hand, as the variation is smaller, the colors are less affected by the response speed and thus few colors are mixed. Also, if the temperature of the display panel 330 is high, the response speed of the liquid crystal is relatively faster and thus an amount of mixed color decreases. If the temperature is low, the response speed is slower. The calculation unit 403 determines the level of correction between the gray scales according to the above points and the level of correction may be calculated by following equations:

If Pᵢₙ_{_{—}}ₙ>Pᵢₙ_{_{—}}₍ₙ₋₁₎,

Pₒᵤₜ_{_{—}}ₙ=Pᵢₙ_{_{—}}ₙ+[Pᵢₙ_{_{—}}ₙ×{Coeff._{rising}×|Pᵢₙ_{_{—}}ₙ−Pᵢₙ_{_{—}}₍ₙ₋₁₎|}^{1/t}] [Equation 1]

If Pᵢₙ_{_{—}}ₙ<Pᵢₙ_{_{—}}₍ₙ₋₁₎,

Pₒᵤₜ_{_{—}}ₙPᵢₙ_{_{—}}ₙ−[Pᵢₙ_{_{—}}ₙ×{Coeff._{falling}×|Pᵢₙ_{_{—}}ₙ−Pᵢₙ_{_{—}}₍ₙ₋₁₎|}^{1/t}] [Equation 2]

wherein Pᵢₙ_{_{—}}ₙ and Pᵢₙ_{_{—}}₍ₙ₋₁₎ are a pixel value of a gray scale of a current color and a pixel value of a gray scale of a previous color, respectively, Coeff. is a response speed of a liquid crystal, Coeff._{rising}, which is a rising response speed, is used, if Pᵢₙ_{_{—}}ₙ>Pᵢₙ_{_{—}}₍ₙ₋₁₎, and Coeff._{falling}, which is a falling response speed, is used, if Pᵢₙ_{_{—}}ₙ<Pᵢₙ_{_{—}}₍ₙ₋₁₎, and ‘t’ is a temperature of a panel.

The above equations are suggested on the assumption that the pixel value of the previous color gives an image to the pixel value of the current color. Therefore, if pixel values of two or more frames affect the correction, equations 1 and 2 may be changed by adding a correction coefficient.

The calculation unit 403 may differentially calculate the correction coefficient for each pixel of the image. This is because pixels in a specific region do not need correction since the (n−1)th color and the nth color have similar pixel values, but pixels in some region may need more correction since differences in colors and pixel values are great.

Accordingly, the image conversion unit 410 can solve the above problem by driving the pixels by adding or removing a correction value with respect to an area, where color mixing occurs due to the response speed of the LCD, according to the variation as shown in FIG. 5. In other words, the image conversion unit 410 outputs an image as a result of differentially correcting the image. To achieve this, the image conversion unit 410 may correct the pixel value by adding or deducting a pixel value to and from the input pixel value as much as the calculated correction coefficient. However, the image conversion unit 410 may select a corrected pixel value stored in the form of a lookup table in cooperation with the memory unit and output the pixel value to the source driver 320_2. Furthermore, during this process, the image conversion unit 410 may output a pixel value for a specific pixel of the R, G, and B as a value of black data.

Although not shown, the image conversion unit 410 may determine which operation is more efficient, changing the gray scale of the color using the correction coefficient, the image correlation, and the setting value, inserting the black data, or performing the blinking of the backlight unit 360, through the determination. For example, if it is determined that an amount of processed data is greater than or equal to a reference value according to a processing cost of data, it may be determined that it is more efficient to perform the blinking rather than changing the gray scale. In this case, the memory unit and a path are turned off by controlling at least one switching element of the switching unit and then a new path to the lamp driver 350 is set, and a control signal is provided, so that the blinking operation of the backlight unit 360 is performed.

For example, FIG. 7 illustrates various examples of driving an LCD and a CFL to insert a black frame. Referring to FIG. 7 (a) to (c), combination 1 indicates a case where a black frame is provided as a pixel value of black and combination 2 indicates a case where the backlight unit 360 is turned off and a blinking operation is performed instead of providing the pixel value of black as in combination 1. These examples may be changed according to a driving frequency of the LCD or the backlight as shown in FIG. 7.

Referring to FIG. 7, the display apparatus according to the exemplary embodiment may determine various ways of applying a pixel according to a driving frequency.

If the display apparatus is driven at 60 Hz, pixel values are applied in the order of “RGBBRGBBR”. If the display apparatus is driven at 48 Hz, pixel values are applied in the order of “RGGBRRGGBR”. If the display apparatus is driven at 40 Hz, pixel values are applied in the order of “RGGBBRRGGBBR”. In these cases, the RGB LEDs of the backlight unit 360 are turned on in sequence, matching with a color of each pixel. If correction is needed as a result of comparing an image of a previous unit frame and an image of a current unit frame during the driving process, a pixel value of black is applied instead of a pixel value of a specific color. Alternatively, instead of applying the pixel value of black, the RGB LEDs of the backlight unit 360 are turned off and the blinking operation is performed. Accordingly, it is possible for the display apparatus to insert the black frame between specific pixels or perform the blinking operation of the backlight unit 360.

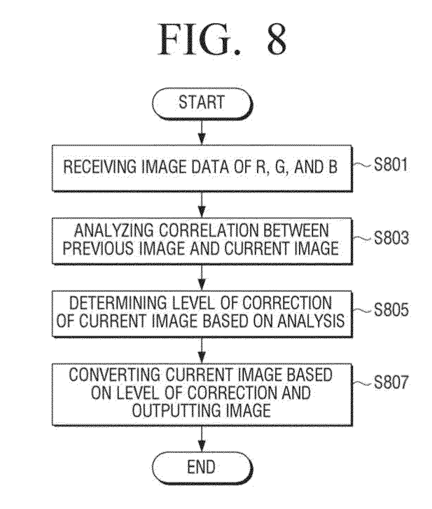

FIG. 8 is a view illustrating a driving method of the display apparatus 301 of FIG. 3 according to an exemplary embodiment.

Referring to FIG. 8 along with FIGS. 3 and 4, the image analysis unit 400 of the display apparatus, more specifically, the correlation analysis unit 401 receives image data of R, G, and B re-arranged and provided by the timing controller 300 (S801).

The correlation analysis unit 401 analyzes a correlation with a currently input unit frame image by referring to a previous unit frame image stored in a separate memory unit (S803). Analyzing the correlation may refer to comparing a specific pixel of the current unit frame image and a specific pixel of the previous unit frame image or neighboring pixels.

The calculation unit 403 calculates the data of R, G, and B according to a result of the analyzing by the correlation analysis unit 401 to determine a level of correction between color gray scales (S805). In this process, the calculation unit 403 may determine the level of correction according to a variation in a liquid crystal stored in the memory unit or a setting value relating to a temperature characteristic of the display panel 330. This has been described above with reference to equations 1 and 2 and thus a detailed description is omitted here.

If the level of correction is determined, the image conversion unit 410 adaptively changes color pixel values of the data of R, G, and B currently input, that is, gray scales, by referring to the correction coefficient, or inserts black data between specific pixels, and outputs the image (S807). Changing the gray scales adaptively refers to not only adjusting a level of a gray scale voltage of a specific pixel but also outputting a pixel value of the specific pixel as black data. For example, if correction should be made with respect to a specific pixel G, the image conversion unit 410 converts a pixel value for an image of the pixel G and outputs the pixel value to the source driver 320_2. In this process, the image conversion unit 410 selects and outputs a correction value stored in the memory unit in the form of a lookup table so that data can be processed swiftly.

Through the above-described process, the display apparatus according to the exemplary embodiment, more specifically, the CFL can realize an image with improved color rendition on the display panel 330 without causing color mixing and retaining a color gamut widely.

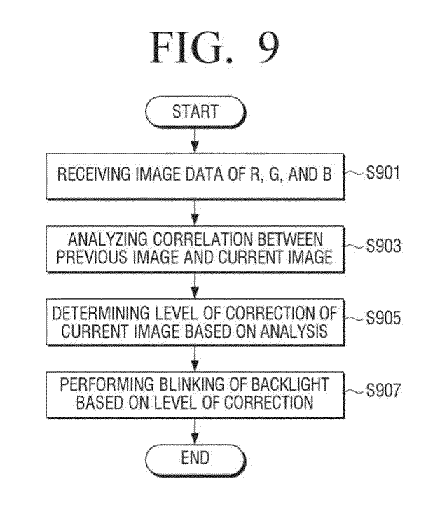

FIG. 9 is a view illustrating a driving method of the display apparatus 301 of FIG. 3 according to an exemplary embodiment.

Referring to FIG. 9 along with FIGS. 4 and 8, the display apparatus according to the exemplary embodiment turns off the backlight unit 360 in synchronization with a time when a specific pixel is displayed or at an interval between a time when one pixel is displayed and a time when another pixel is displayed. That is, the display apparatus performs a so-called blinking operation, rather than converting a pixel value of a specific pixel and outputting the pixel as in the previous exemplary embodiment.

As in operations S801 to S805 of FIG. 8, the display apparatus according to the second exemplary embodiment receives image data of R, G, and B (S901), analyzes a correlation between a previous image and a current image (S903), and determines a level of correction of the current image according to a result of the analyzing (S905). The relevant operations have been described above with reference to FIG. 8 and thus a detailed description is omitted.

If the level of correction of the current image is determined, that is, if it is determined that the blinking operation of the backlight unit 360 is performed at a time when a specific pixel is output or at an interval between a time when one pixel is output and a time when another pixel is output, the display apparatus performs the blinking operation of the backlight unit 360 using a corresponding control signal (S907).

In order to perform the blinking operation of the backlight unit 360, the image conversion unit 410 may newly generate a relevant control signal or change a control signal provided from the timing controller 300, and then provides the control signal to the lamp driver 350. The lamp driver 350 turns off the LEDs of a specific color of the backlight 360 in synchronization with the displaying time of the specific pixel or the interval between the displaying times of the pixels in response to the control signal.

Through the above-described process, the display apparatus can display an image with improved color rendition on the display panel 330 as in the first exemplary embodiment.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for driving a display apparatus, the method comprising:
receiving a first image;
correcting a driving voltage for at least one of a red (R) frame, a green (G) frame, and a blue (B) frame generated from the first image, according to a pixel value of a previously driven frame; and
displaying the R frame, the G frame, and the B frame in sequence according to the corrected driving voltage.

2. The method as claimed in claim 1, wherein the correcting the driving voltage comprises correcting a driving voltage of one of the R frame, the G frame, and the B frame that is driven second, according to a pixel value of the frame that is driven first, or correcting a driving voltage of the frame that is driven third, according to a pixel value of the frame that is driven second.

3. The method as claimed in claim 1, wherein the correcting the driving voltage comprises correcting the driving voltage according to a pixel value of a second image that is received before the first image is received.

4. The method as claimed in claim 1, wherein the correcting the driving voltage comprises according to a difference in pixel values between the previously driven frame and the at least one of the R frame, the G frame and the B frame which driving voltage is to be corrected.

5. The method as claimed in claim 1, wherein the correcting the driving voltage comprises correcting the driving voltage for each region of the at least one of the R frame, the G frame and the B frame.

6. The method as claimed in claim 1, wherein the correcting the driving voltage comprises correcting the driving voltage according to a temperature factor.

7. The method as claimed in claim 1, wherein the correcting the driving voltage comprises, if the R frame, the G frame, and the B frame are driven in sequence, correcting the driving voltage so that color mixing is reduced.

8. The method as claimed in claim 1, wherein the displaying comprises displaying the R frame, the G frame, and the B frame in sequence by synchronizing a color filterless liquid crystal display (CFL) and an RGB backlight.

9. The method as claimed in claim 1, wherein the displaying comprises inserting a frame of a specific gray scale value when displaying the R frame, the G frame, and the B frame in sequence.

10. The method as claimed in claim 1, wherein the displaying comprises turning off a backlight in a specific section when displaying the R frame, the G frame, and the B frame in sequence.

11. A method for driving a display apparatus, the method comprising:
receiving a first image; and
inserting at least one color mixing prevention section between an R frame, a G frame, and a B frame generated from the first image; and
displaying the R frame, the G frame, and the B frame in sequence.

12. The method as claimed in claim 11, wherein the displaying comprises inserting a frame of a specific gray scale value when displaying the R frame, the G frame, and the B frame in sequence.

13. The method as claimed in claim 11, wherein the displaying comprises turning off a backlight in a specific section when displaying the R frame, the G frame, and the B frame in sequence.

14. A display apparatus comprising:
an image correction unit which receives a first image and corrects a driving voltage for at least one of an R frame, a G frame, and a B frame generated from the first image, according to a pixel value of a previously driven frame; and
a display panel which displays the R frame, the G frame, and the B frame in sequence according to the corrected driving voltage.

15. The display apparatus as claimed in claim 14, wherein the image correction unit corrects a driving voltage of one of the R frame, the G frame, and the B frame that is driven second, according to a pixel value of one of the R frame, the G frame, and the B frame that is driven first, or corrects a driving voltage of one of the R frame, the G frame, and the B frame that is driven third according to a pixel value of one of the R frame, the G frame, and the B frame that is driven second.

16. The display apparatus as claimed in claim 14, wherein the image correction unit corrects the driving voltage according to a pixel value of a second image that is received before the first image is received.

17. The display apparatus as claimed in claim 14, wherein the image correction unit corrects the driving voltage according to a difference in pixel values between the previously driven frame and the at least one of the R frame, the G frame and the B frame which driving voltage is to be corrected.

18. The display apparatus as claimed in claim 14, wherein the image correction unit corrects the driving voltage for each region of the at least one of the R frame, the G frame and the B frame.

19. The display apparatus as claimed in claim 14, wherein the image correction unit corrects the driving voltage according to a temperature factor.

20. The display apparatus as claimed in claim 14, wherein, if the R frame, the G frame, and the B frame are driven in sequence, the image correction unit corrects the driving voltage so that color mixing is reduced.

21. The display apparatus as claimed in claim 14, wherein the display panel is synchronized with an RGB backlight and displays the R frame, the G frame, and the B frame in sequence.

22. The display apparatus as claimed in claim 14, wherein the image correction unit inserts a frame of a specific gray scale value when displaying the R frame, the G frame, and the B frame in sequence.

23. The display apparatus as claimed in claim 14, wherein the image correction unit turns off a backlight in a specific section when displaying the R frame, the G frame, and the B frame in sequence.

24. A display apparatus comprising:
an image correction unit which inserts at least one color mixing prevention section between an R frame, a G frame, and a B frame generated from a received first image; and
a display panel which displays the R frame, the G frame, and the B frame in sequence.

25. The display apparatus as claimed in claim 24, wherein the image correction unit inserts a frame of a specific gray scale value when displaying the R frame, the G frame, and the B frame in sequence.

26. The display apparatus as claimed in claim 24, wherein the image correction unit turns off a backlight in a specific section when displaying the R frame, the G frame, and the B frame in sequence.

27. A method for driving a display apparatus, the method comprising:
receiving a current image currently input and a previous image input prior to the current image;
analyzing a correlation of an image by comparing the previous image and the current image; and
determining a level of correction of the current image according to the analysis of the correlation and converting the current image according to the level of correction.

28. The method as claimed in claim 27, wherein the converting the current image comprises converting pixel values for pixels of a unit frame having a specific color, when a unit frame of the current image is displayed in sequence on a pixel basis.

29. The method as claimed in claim 28, wherein the converting the pixel values comprises converting the pixel values into black data.

30. The method as claimed in claim 27, wherein the converting the current image comprises inserting a black frame between unit frames of two pixels having a specific color, when a unit frame of the current image is displayed in sequence on a pixel basis.

31. The method as claimed in claim 27, wherein the converting the current image comprises turning off a backlight in synchronization with a time at which pixels of a unit frame having a specific color are displayed, when a unit frame of the current image is displayed in sequence on a pixel basis.

32. The method as claimed in claim 27, wherein the converting the current image comprises turning off a backlight in synchronization with a time between when one unit frame of unit frames of two pixels having a specific color is displayed and when the other unit frame is displayed, when a unit frame of the current image is displayed in sequence on a pixel basis.

33. A display apparatus comprising:
an image analysis unit which analyzes a correlation of an image by comparing a current image and a previous image input prior to the current image, and determines a level of correction of the current image according to the analysis of the correlation; and
an image conversion unit which converts pixel values of pixels of a unit frame having a specific color in the current image based on the level of correction, and outputs the pixel values.

34. The display apparatus as claimed in claim 33, wherein the image analysis unit comprises:
a correlation analysis unit which analyzes the correlation of the image; and
a calculation unit which calculates a correction coefficient to determine the level of correction.

35. The display apparatus as claimed in claim 33, wherein the image analysis unit is operated in association with a first memory unit, and
wherein the first memory unit stores the previous image and the current image.

36. The display apparatus as claimed in claim 33, wherein the image conversion unit converts the current image by converting the pixel values of the pixels of the unit frame having the specific color or inserting a black frame between unit frames of two pixels having a specific color, when a unit frame image is driven in sequence on a basis of R, G, and G pixels.

37. The display apparatus as claimed in claim 33, wherein the image conversion unit is operated in association with a second memory, and
wherein the second memory pre-stores the pixel values as a correction value in a form of a lookup table.

38. The display apparatus as claimed in claim 33, wherein the image conversion unit converts the pixel values to adjust a gamma voltage of the pixels of the unit frame having the specific color.

39. The display apparatus as claimed in claim 38, wherein the converted pixel values of the pixels of the specific color comprise a value of black data.

40. The display apparatus as claimed in claim 33, wherein the image conversion unit uses at least one of the correlation, the level of correction, a response speed of a liquid crystal, and a temperature characteristic of a panel to convert the pixel values.

41. A display apparatus comprising:
an image analysis unit which analyzes a correlation of an image by comparing a current image and a previous image input prior to the current image, and determines a level of correction of the current image according to the analysis of the correlation; and
an image conversion unit which turns off a backlight, when a unit frame having a specific color in the current image is displayed in relation to determination of the level of correction.

42. The display apparatus as claimed in claim 41, wherein the image conversion unit turns off the backlight in synchronization with a time at which the pixels of the unit frame having the specific color are displayed or a time between when one unit frame of unit frames of two pixels having a specific color is displayed and when the other unit frame is displayed, when an image of a unit frame is driven in sequence on a basis of R, G, and B pixels.

43. The display apparatus as claimed in claim 41, wherein the image conversion unit is additionally operated in association with a lamp driver, and
wherein the lamp driver turns off the backlight according to a request of the image conversion unit.

44. The display apparatus as claimed in claim 43, wherein the image conversion unit generates a control signal for the request and provides the control signal to the lamp driver so that the backlight is operated in synchronization with the control signal.

45. A method for preventing color mixing of a color filterless liquid crystal display (CFL), the method comprising:
receiving a first image comprising a plurality of pixels;
analyzing variations between the plurality of pixels of the first image;
selecting at least one pixel having a first value requiring color compensation; and
converting the first value of the at least one pixel to a second value to generate a second image.

46. The method according to claim 45, wherein color mixing is prevented by one of inserting a black frame between the plurality of pixels and converting the at least one pixel having a first value to a black frame.

47. The method according to claim 45, wherein the converting the first value of the at least one pixel to a second value comprises adjusting a gray scale of color.

48. The method according to claim 45, wherein the converting the first value of the at least one pixel to a second value is performed by turning off a backlight.
